(19) United States
(12) Patent Application Publication
(10) Pub. No.: US 2009/0041226 A1
(43) Pub. Date: Feb. 12, 2009

(54) System and Method for Using the Reliability of an Agent's Connectivity as an Agent Selection Criteria

(75) Inventors: Fadi R. Jabbour, Sunnyvale, CA (US); David C. Lee, Sunnyvale, CA (US); Eric H. Lee, San Jose, CA (US); Johnny H. Lee, San Gabriel, CA (US); Christopher E. Pearce, Dallas, TX (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/835,511

(22) Filed: Aug. 8, 2007

(51) Int. Cl. H04M 3/00

(52) U.S. Cl. 379/265.1; 379/265.11; 379/265.14

(57) ABSTRACT

A method for routing contacts to resources comprises receiving a contact to be routed to one of a plurality of resources. The method then proceeds by determining a reliability score for at least one of the plurality of resources. The reliability score is based at least in part upon connection statistics for at least one of the plurality of resources. The method continues by determining a particular resource of the plurality of resources to which to route the contact. This determination is based at least in part upon the reliability scores that were determined. The method concludes by routing the contact to the particular resource.

### TECHNICAL FIELD OF THE INVENTION

This invention relates in general to the field of contact center communications and more particularly to a system and method for using the reliability of an agent's connectivity as an agent selection criteria.

### BACKGROUND OF THE INVENTION

Various agent selection criteria are used in past contact centers to determine the agent to whom to route a contact. Some examples include the agent's skill set and proficiency in the relevant skills, the agent's longest idle time, the agent's average talk time, and the agent's geographic location. These criteria increase the likelihood that the contact will be routed to an agent who has the appropriate expertise to service the contact, but the criteria fail to address whether the agent has a network connection sufficiently reliable to actually service the contact.

In our increasingly mobile computing world, contact centers are becoming more decentralized and geographically disperse. Agents are increasingly utilizing mobile devices whose connections are not always reliable. As such, contact centers wishing to route a contact to an agent who has the appropriate expertise as well as a sufficiently reliable network connection cannot do so using only past agent selection criteria.

### BRIEF DESCRIPTION OF THE DRAWINGS

To provide a more complete understanding of the present invention and features and advantages thereof, reference is made to the following description, taken in conjunction with the accompanying figures, wherein like reference numerals represent like parts, in which:

FIG. 1 is a simplified block diagram of a contact distribution system that routes contacts based at least in part on connection reliability in accordance with an embodiment of the present invention;

FIG. 2 is a simplified block diagram of a teleconference system that initiates conference calls when all participants have a minimum level of connection reliability;

FIG. 3 is one embodiment of reliability scores used with the system of FIG. 1;

FIG. 4 is one embodiment of reliability statistics used with the system of FIG. 1; and

FIG. 5 is a flowchart illustrating one example method for routing a contact based at least in part on connection reliability.

### DESCRIPTION OF EXAMPLE EMBODIMENTS

Overview

In one embodiment, a method for routing contacts to resources is provided. The method starts by receiving a contact to be routed to one of a plurality of resources. The method then proceeds by determining a reliability score for at least one of the plurality of resources. The reliability score is based at least in part upon connection statistics for at least one of the plurality of resources. The method continues by determining a particular resource of the plurality of resources to which to route the contact. This determination is based at least in part upon the reliability scores that were determined. The method concludes by routing the contact to the particular resource.

In another embodiment, a contact routing system having a contact distribution server and a plurality of resources is provided. The plurality of resources are communicatively coupled to the contact distribution server. The contact distribution server is operable to receive a contact. The contact distribution server is further operable to determine a reliability score for each of the plurality of resources based at least in part upon connection statistics for the plurality of resources. The contact distribution server is also operable to determine the resource to which to route the contact based at least upon the determined reliability scores. The contact distribution server is further operable to route the contact to the resource. The plurality of resources is each operable to receive the contact from the contact distribution server.

Various embodiments of the invention may have some, none or all of the technical advantages discussed below. One advantage is that by using connection reliability in the routing calculus, contact centers may route contacts to agents that will more likely have reliable connections. Thus, as compared to prior systems there may be a reduction in the overall number of contacts that are lost or dropped. The efficiency of contact centers also may increase over past contact centers. Another advantage may be the ability to distinguish among customers by providing more reliable service to preferred customers.

Description

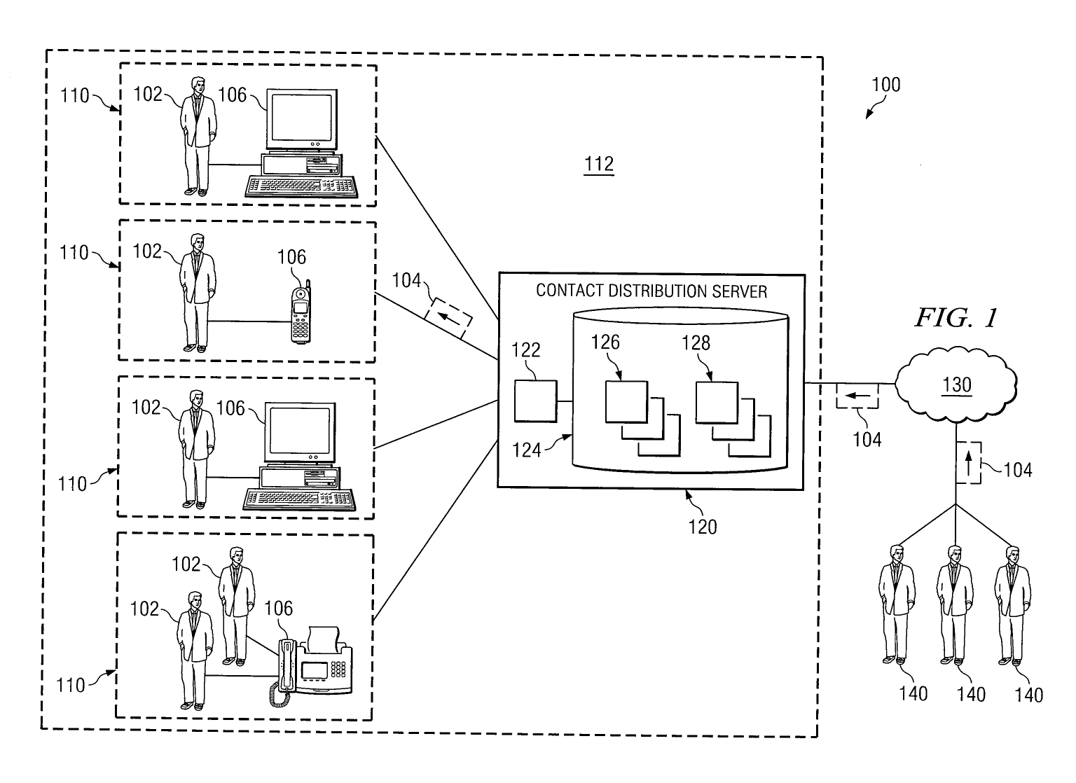

FIG. 1 is a simplified block diagram of a contact distribution system 100, which includes a contact center 112 having resources 110 and a contact distribution server 120. A resource 110 comprises a computing device 106 that can receive contacts from and transmit responses of agents 102 to the contact distribution server 120. In some embodiments, the resource 110 may also comprise an agent 102. A contact 104 is any communication that may be transmitted over a network 130, including an electronic mail message (e-mail), an instant message, a facsimile, a telephony message, or any other type of voice, video, or data communication that may be serviced by a resource 110. Firms usually provide contact centers 112 to support customers 140. Generally, a customer 140, in need of help, initiates a contact 104 to be serviced ultimately by an agent 102. The contact distribution server 120 may receive the contact 104 and route it to the appropriate resource 110 using, among other factors, the past connection reliability of the resource 110. The past connection reliability of the resources 110 may be quantified and reflected in the reliability scores 126.

System 100 may have several advantages over the prior mechanisms of routing contacts 104. By using reliability scores 126, contact distribution server 120 may route contacts 104 to resources 110 that will likely have reliable connections, resulting in fewer lost or dropped contacts 104. The efficiency of processing contacts 104 also may increase with embodiments of the present invention over past contact distribution systems. Another advantage may be the ability to provide more reliable service to preferred customers 140. Various embodiments may have all, some, or none of these advantages.

Contact distribution server 120 is a computing device that contains a memory 124 and a processor 122, which is capable of routing a contact 104. It may be a telephony switch or router, an e-mail router, an instant message router, or any combination of hardware and software capable of processing contacts 104 and forwarding them to various resources 110. In some embodiments, the memory 124 may be capable of storing a plurality of reliability scores 126 corresponding to the connection reliability of resources 110. The contact distribution server 120 may use the reliability scores 126 to determine the appropriate routing for a contact 104. One example contact distribution server 120 is an automated call distributor (ACD), which may be utilized in contact centers 112 that are call centers. Typically, an ACD may use several indicators to determine the appropriate resource 110 to which to route a call, including, but not limited to, the skill sets and proficiency in the relevant skills of the various agents 102, the longest idle time of the various agents 102, the average talk time of each agent 102, and the geographic location of each agent 102. In addition to these indicators, system 100 allows a server 120 to utilize the past connection reliability of the resources 110 in its routing calculus.

A contact distribution server 120 may also be capable of tracking reliability statistics 128 for the resources 110. In so doing, a contact distribution server 120 may periodically check the status of each resource 110 and record the result. For example, if the resource 110 is a computing device connected to the contact distribution server 120 through a network that supports the internet control message protocol (ICMP), then the contact distribution server 120 may transmit an echo request message to the resource 110. If the resource 110 does not reply with an echo response message within a certain amount of time, then the contact distribution server 120 may record the lack of a timely echo response with the other reliability statistics 128. A contact distribution server 120 may also record when a contact 104 is dropped by a resource 110 and when software running on resource 110 stops functioning or crashes. There are many other ways that a contact distribution server 120 may track the connection reliability of resources 110.

A resource 110 comprises a computing device 106, an agent 102, and/or any interfacing hardware and/or software used to establish a connection with server 120. The computing device 106 is any combination of hardware and software that may receive a contact 104 and communicate that contact 104 to an agent 102. For example, a computing device 106 may be a desktop or laptop computer, a mobile phone, an internet protocol (IP) phone, a soft phone on a laptop, an e-mail client or server, a personal digital assistant (PDA), or a fax machine. The agent 102 may be human or automated. Each resource 110 has a unique identifier and may be communicatively coupled with a contact distribution server 120. A resource 110 also may be configured to update a contact distribution server 120 with reliability statistics 128. Such reliability statistics 128 may track, for example, when contacts 104 are dropped by a resource 110, when a resource 110 has a slow connection, and when a resource 110 becomes inoperable or otherwise becomes unavailable. Reliability statistics 128 may further track the number of dropped media packets, number of call signaling transmissions required to establish a connection, number of missed signaling responses, and in the case of wireless devices participating in the call, the measured strength of the radio signal. Reliability statistics 128 may be used to calculate a reliability score 126 for a particular resource 110.

A reliability score 126 is an indicator of the connection reliability of a resource 110. Reliability scores 126 may be, for example, numbers ranging from zero to nine or letters ranging from A to F. Different reliability scores 126 may be determined for a particular resource 110 based on the type of connection sought to be established. For example, a first score 126 may be applicable to a voice and video connection to be established, a second score 126 may be applicable to a voice-only connection to be established, and a third score 126 may be applicable to data only connections. A resource 110 with a more reliable past connection history may have a higher reliability score 126 than those resources 110 with less reliable connection histories.

A resource 110 that has not been connected for a long period of time may have a low reliability score 126. However, the reliability score 126 for a particular resource 110 may reflect more than just whether that particular resource 110 is available or connected at a particular point in time. The reliability score 126 may reflect the reliability statistics 128 over a period of time. This period of time may be the prior second, the prior minute, the prior hour, the prior day, the prior week, or any suitable prior time period. In some embodiments, the reliability score 126 may be a predictive parameter based on historical trends in the reliability statistics 128. For example, a particular resource 110 may have a trend of being less reliable on Tuesdays after 5:00 p.m. A reliability score 126 based solely on the most recent hour may not capture the trend and may be higher than what would be warranted if a fuller history were taken into account. As a result, a contact 104 may be routed to the resource 110 on Tuesday at 5:01 p.m., despite the fact that the actual connection reliability may be much lower than the reliability score 126 reflects. Trends in the reliability statistics 128 may be discovered using suitable data mining techniques.

The reliability score 126 may be used in conjunction with other indicators or it may be the sole basis upon which contact distribution server 120 routes contacts 104. The contact distribution server 120 may assign various weights to the different indicators in determining the resource 110 to which to route the contact 104. For example, the same or different weights may be assigned to the time of the disconnection (or failure to establish connection), nature of the disconnection (or failure to establish connection), reason for disconnection (or failure to establish connection), length of disconnection (or failure to establish connection), and so forth.

In operation, a customer 140 communicates a contact 104 that is routed to a contact center 112. The contact distribution server 120 receives the contact 104 and determines the resource 110 to which to route the contact 104. When making this determination, the contact distribution server 120 may rely on the reliability scores 126 for at least one of the resources 110 and other information, such as the abilities of the agents 102. The reliability scores 126 may be calculated dynamically based on the reliability statistics 128 or they may be accessed from memory 124. The reliability scores 126 may be periodically updated such that recent reliability scores 126 are available in memory 124. Once the appropriate resource 110 is determined, using at least in part the reliability scores 126 described above, the contact distribution server 120 may route the contact 104 to that resource 110.

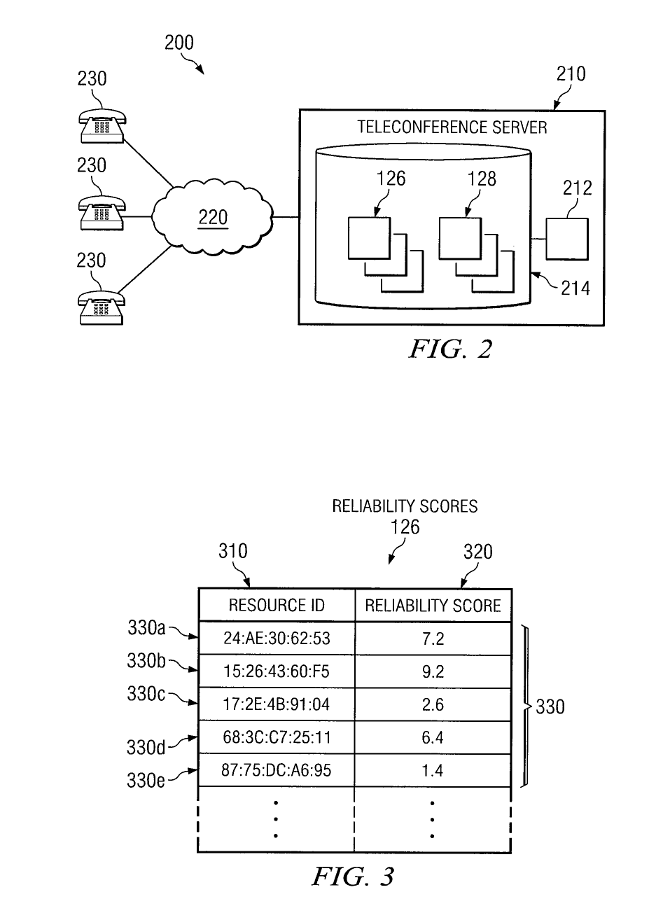

FIG. 2 is a simplified block diagram of a teleconference system 200, which includes a teleconference server 210 and telephony devices 230 all communicatively connected through a network 220. Generally, the teleconference server 210 may initiate a teleconference among a group of telephony devices 230 after each of the telephony devices 230 have attained a predetermined level of connection reliability, as indicated by a minimum reliability score 126 that is expected to continue throughout the duration of the conference call. This embodiment may have the advantage of increasing the productivity of teleconferences, by reducing the likelihood that a required participant may lose his or her connection after beginning the conference. Although the term “call” and “telephony” is used, this embodiment contemplates conferences involving more than just voice calls; the terms are used to refer also to multimedia and text based conferences.

A telephony device 230 is any combination of hardware and software that provides the ability for a remote user to conduct a voice, video, and/or data conference with other remote users. Examples include, but are not limited to, IP telephones, videophones, mobile telephones, internet chat software, and teleconferencing hardware and/or software. Telephony devices 230 are communicatively coupled to one another and to a teleconference server 210 through a network 220.

A teleconference server 210 is a computing device having a processor 212 and a memory 214. The processor 212 has the ability to configure conference call parameters and to initiate and maintain conference calls. The memory 214 may contain reliability scores 126 and reliability statistics 128 for telephony devices 230. The teleconference server 210 may be configured to store only those scores 126 and statistics 128 for telephony devices 230 that may be designated to participate in an upcoming conference call.

In operation, the teleconference server 210 is preconfigured to initiate, at a target time, a conference call among particular telephony devices 230. For example, suppose three individuals want to hold a conference call at 5:00 p.m. on Tuesday. Suppose further that the teleconference server 210 is configured to initiate a conference call with the telephony devices 230 at 5:00 p.m. on Tuesday. The teleconference server 210, at 4:00 p.m. on Tuesday, may begin to monitor the connection reliability of the telephony devices 230 and may begin tracking reliability statistics 128. At 5:00 p.m., the teleconference server 210 may calculate the reliability scores 126 to determine if all of the participants have a reliable connection. If all of the reliability scores 126 are above a minimum threshold, then the teleconference server 210 may initiate the conference. Otherwise, the teleconference server 210 may continue to monitor and track reliability statistics 128 until the reliability score 126 for all of the devices reaches the minimum threshold.

If the reliability scores 126 for all of the devices fail to reach the minimum threshold after a predetermined length of time after the target time, the teleconference server 210 may send a message to the participants explaining the delay and may provide several options to the participants. Participants may be able to reschedule the conference call, continue to wait, or proceed with the conference call despite the low reliability score 126 for one or more of the participants. The teleconference server 210 may be preconfigured to proceed with the conference call if certain participants have reliable connections, if a certain number of participants have reliable connections, or if any number of predetermined criteria are met.

FIG. 3 is one embodiment of reliability scores 126. In general, reliability scores 126 may be stored in a two-dimensional data structure containing the identifications of each resource 110 stored in the resource identification column 310, the actual reliability scores 126 stored in the reliability score column 320, and rows 330. A resource identification 310 is a unique identifier for each resource 110. The types of unique device identifiers are varied and may depend on the type of computing devices 106 used in the contact center 112. For example, for a fax machine or a telephone, the unique identifier could be the telephone number. For a resource 110 connected over IP, such as with an IP phone or internet conferencing software, the identifier may be an IP address or a session initiation protocol (SIP) address. For laptops or soft phones running on laptops, a unique identifier may be a media access control (MAC) address or a static IP address. If each agent 102 has a unique identifier, then that may also be stored in column 310.

The reliability score column 320 stores the reliability score 126 of at least one of the resources 110. Although illustrated in the present example as numerical, the reliability scores 126 may also be alphabetical, alphanumerical, or any series of symbols that may express the relative magnitudes of connection reliability.

In operation, system 100 may receive a contact 104 and access the rows 330 to retrieve the reliability scores 126 stored in reliability score column 320. In this illustrated embodiment, the MAC addresses of five resources 110 are shown in column 310 along with their respective reliability scores 126 shown in column 320. If the routing of contact 104 were based solely on the reliability scores 126, then the resource 110 associated with the highest reliability score 126 would have the contact 104 routed to it. In this example, the highest reliability score is “9.2,” which is stored in row 330b. The resource identification in column 310 associated with “9.2” is “15:26:43:60:F5”. Thus, the contact distribution server 120 would route the contact 104 to the resource 110 having the MAC address of “15:26:43:60:F5.”

In some embodiments, the contact distribution server 120 may utilize other information related to the agents 102, such as the skill set and proficiency of each agent 102. In those embodiments, the contact distribution server 120 may use an algorithm that accounts for the connection reliability of the resources 110 as well as the skills of the agents 102 associated with the resources 110, when determining the appropriate resource 110 to which to route.

In the illustrated embodiment, reliability scores 126 are stored in a multi-dimensional data structure. However, reliability scores 126 may be arranged in any appropriate format. It will be understood that each record 330 may include none, some, or all of the example data. In one embodiment, each record 330 may include links, foreign keys, or pointers to another table. The illustrated reliability scores 126 data are merely examples and system 100 contemplates any other suitable data that allows system 100 to route a contact 104 based in part on the reliability of the resources 110. Moreover, reliability scores 126 may be separated into or combined with multiple tables or files without departing from the scope of the invention.

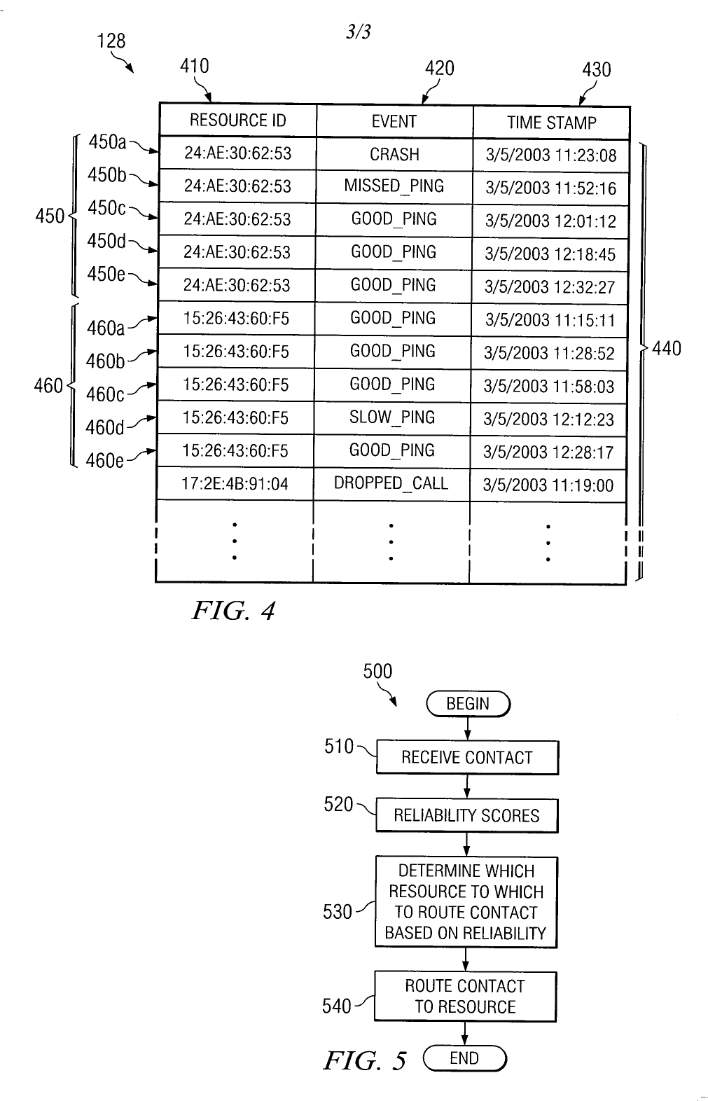

FIG. 4 is one embodiment of reliability statistics 128. One way of determining reliability scores 126 is by using the reliability statistics 128. In general, reliability statistics 128 may be stored in a two-dimensional data structure containing a resource identification column 410, a connection event column 420, a timestamp column 430, and rows 440. A resource identification 410 is a unique identifier for each resource 110. The types of unique identifiers of resources 110 are varied and may depend on the type of computing device 106 used in the contact center 112. For example, for a fax machine or a telephone, the unique identifier could be the telephone number. For a resource 110 connected over IP, such as with an IP phone or internet conferencing software, the identifier may be a static IP address or a SIP address. For laptops or soft phones running on laptops, a unique identifier could be a MAC address or a static IP address. A resource 110 may also be identified by its agent 102, if each agent has a unique identifier.

The connection event column 420 stores a value associated with various connection events that could occur during the operation of a resource 110. For example, a resource 110 may drop a call (dropped_call), miss responding to an ICMP echo request (missed_ping), or have its software become inoperable (crash). A resource 110 may also respond successfully to an ICMP echo request (good_ping) or may have a slow response to such an echo request (slow_ping). There may be several other types of connection events not shown that may be tracked in reliability statistics 128. Also, the categories of connection events may be as detailed or abstract as needed. For example, in one embodiment, there could be only two categories of connection events: good connections and bad connections. In another embodiment, many categories of connection events could be maintained.

In operation, a contact distribution server 120 may periodically send an ICMP echo request to each resource 110 and record responses received from each resource 110 in the reliability statistics 128. Also, each resource 110 may update the contact distribution server 120 each time the resource 110 drops a call or becomes inoperable. As the statistics are tracked, another process may be used to read the statistics to calculate the reliability scores 126. This process could occur in real-time, in order to updated the reliability scores 126 each time a connection event is recorded. The calculation of reliability scores 126 may also be ad hoc in order to update the reliability score 126 for each resource as needed; or may be periodic in order to update the reliability score 126 after a certain time period, such as every ten minutes.

Although the description is detailed with respect to an ICMP echo request, other types of request/response transactions may also be used, including layer 2 keepalives between endpoints and wireless controllers/wired switches, TCP keepalives, and call signaling request/response pairs.

There are several ways to determine reliability scores 126 from reliability statistics 128. One algorithm to calculate a reliability score 126 is to give each type of connection event a score and then average each score over a given time period. For example, suppose “dropped_call” events are given a score of 0, “crash” events are given a score of 2, “missed_ping” events are given a score of 4, “slow ping” events are given a score of 6, and “good_ping” events are given a score of 10. Next, suppose that the data shown in FIG. 4 was tracked for the resources 110 identified in the resource identification column 410 and the current time is 12:45 p.m. on Mar. 5, 2003. Now, suppose a reliability score 126 was calculated based on the past two hours for resource 110 having a MAC address of “24:AE:30:62:53.” In calculating the reliability score 126, system 100 may find rows 450 having “24:AE:30:62:53” stored in the resource identification column 410. System 100 may then add the values corresponding to each connection event stored in column 420; the sum in this case is 36 (2+4+10+10+10). Finally, system 100 may average the values to arrive at a reliability score 126, which in this case is “7.2.” This reliability score 126 could be stored as shown in row 330a of FIG. 3. The same could be done for resource 110 having a MAC address of “15:26:43:60:F5,” which would yield a reliability score 126 of “9.2.”

Many other algorithms exist to determine reliability scores 126 from reliability statistics 128. For example, in the scenario described above the algorithm may be changed such that more weight is given to more recent events such that recent connection events are more heavily reflected in the reliability score 126. Data mining techniques known in the art may also be used to find trends in the statistics 128 to be used in determining a reliability score 126. Continuing the example above, suppose that every day between 12:45 p.m. and 2:00 p.m., resource 110 having MAC address “15:26:43:60:F5” experiences a slow connection. Suppose further that a contact 104 is received at 12:50 p.m. with the current reliability statistics 128 as reflected in FIG. 4. Although a reliability score 126 based solely on the prior two hours will at some future time reflect the slow connection, the reliability score 126 determined at 12:50 p.m. would still be “9.2,” as determined from the current reliability statistics 128. By discovering the trend, system 100 may adjust downward the “9.2” reliability score 126 to reflect the trend.

In a particular embodiment, system 10 can evaluate the current reliability trend for a plurality of resources 110 and either prioritize particular resources 110 whose reliability is increasing or deprioritize a particular resource 110 whose reliability is decreasing. For example, suppose a particular wireless based resource 110. If, over a given time interval, the resource 110 has consistently reported a drop in signal strength, it may indicate that the resource 110 is about to lose its wireless connection and should not be selected for new incoming calls. Conversely, if a resource 110 with historically low reliability scores 126 due to poor signal strength begins reporting increasing signal strength over a given time interval, server 120 may start directing incoming calls, such as a contact 104, toward it despite its otherwise low reliability score 126.

In the illustrated embodiment, reliability statistics 128 are stored in a multi-dimensional data structure. However, reliability statistics 128 may be arranged in any appropriate format. It will be understood that each record 440 may include none, some, or all of the example data. In one embodiment, each record 440 may include links, foreign keys, or pointers to another table. The illustrated reliability statistics 128 data are merely examples and system 100 contemplates any other suitable data that allows system 100 to route a contact 104 based at least in part on the reliability of the resources 110. Moreover, reliability statistics 128 may be separated into or combined with multiple tables or files without departing from the scope of the invention.

FIG. 5 illustrates one example of the routing based at least in part on connection reliability. Method 500 generally depicts the steps for various aspects of routing a contact 104 to a resource 110 based at least in part on the reliability scores 126 of resources 110.

The method 500 begins at step 510 where system 100 receives a contact 104. The method 500 then proceeds to step 520 where system 100 determines the reliability scores 126 for various resources 110 that may service the contact 104. The reliability scores 126 may be calculated dynamically based on the reliability statistics 128 or they may be retrieved from memory 124. At step 530, system 100 may determine the resource 110 to which to route the contact 104. System 100 may make the determination based solely on the reliability scores 126 or based on the reliability scores 126 along with other information, such as the skills and geographic location of the agents 102. Finally, the method proceeds to step 540 where the contact 104 is routed to the appropriate resource 110. The execution of method 500 ends at step 540.

System 100 may perform steps not shown in FIG. 5. Likewise, system 100 may omit steps or perform steps in an order different from those shown in FIG. 5 while still being contemplated by the present invention. Method 500 is merely one embodiment of the claimed invention.

Numerous other changes, substitutions, variations, alterations, and modifications may be ascertained by those skilled in the art and it is intended that the described embodiments encompass all such changes, substitutions, variations, alterations, and modifications as falling within the spirit and scope of the appended claims. Moreover, the described embodiments are not intended to be limited in any way by any statement in the specification that is not otherwise reflected in the appended claims.

What is claimed is:

1. A method for routing contacts to resources, comprising:
receiving a contact;
determining a reliability score for each of a plurality of resources based at least in part upon connection statistics for each of the plurality of resources;
determining a particular resource of the plurality of resources to which to route the contact based at least in part upon the determined reliability scores; and
routing the contact to the particular resource.

2. The method of claim 1, wherein the connection statistics are based on at least one of the set comprising: dropped connections, connection speed, number of dropped packets, signal strength, and failure to establish connections.

3. The method of claim 1, wherein the connection statistics used to determine at least one reliability score are associated with a particular time period.

4. The method of claim 3, wherein the particular time period is one of the set comprising: a preceding second, a preceding minute, a preceding hour, a preceding day, and a preceding week.

5. The method of claim 3, wherein determining the reliability score further comprises:
assigning weights to the connection statistics, whereby the connection statistics associated with more recent times in the particular time period have higher weights than the connection statistics associated with earlier times in the particular time period;
determining a reliability score based on the assigned weights.

6. The method of claim 1, wherein determining the reliability score for each of the plurality of resources further comprises:
predicting a future connection reliability for at least one of the plurality of resources using past trends in the connection statistics; and
determining the reliability score for the at least one of the plurality of resources based on the predicted connection reliability for the at least one of the plurality of resources.

7. The method of claim 1, further comprising tracking connection statistics for a plurality of resources.

8. The method of claim 7, wherein tracking connection statistics further comprises
sending periodically a request message to at least one of the plurality of resources;
waiting a predetermined period of time for a response; and
recording a result based on the response and whether the response is received within the predetermined period of time.

9. The method of claim 1, wherein the contact comprises at least one of the set comprising: a voice communication, a video communication, and a data communication.

10. The method of claim 1,
wherein the plurality of resources comprises a plurality of teleconference devices;
wherein receiving the contact comprises receiving a conference call request for a plurality of teleconference devices to begin at a target time;
wherein determining the reliability score comprises:
determining a first reliability score for a first of the plurality of teleconference devices based at least in part upon connection statistics for the first of the plurality of teleconference devices;
determining a second reliability score for a second of the plurality of teleconference devices based at least in part upon connection statistics for the second of the plurality of teleconference devices; and
wherein determining a particular resource to which to route the contact comprises determining whether the first and the second reliability scores exceed a minimum threshold; and
wherein routing the contact to the particular resource comprises initiating a conference call between the plurality of teleconference devices if the first and the second reliability scores exceed the minimum threshold.

11. The method of claim 10, further comprising tracking connection statistics for the first and second of the plurality of resources.

12. A contact routing system, comprising:
a contact distribution server, operable to:
receive a contact;
determine a reliability score for each of a plurality of resources based at least in part upon connection statistics for each of the plurality of resources;
determine a particular resource of the plurality of resources to which to route the contact based at least in part upon the determined reliability scores; and
route the contact to the particular resource; and
the plurality of resources communicatively coupled to the contact distribution server, wherein the particular resource is operable to receive the contact from the contact distribution server.

13. The system of claim 12, wherein the connection statistics are based on at least one of the set comprising: dropped connections, connection speed, number of dropped packets, signal strength, and failure to establish connections.

14. The system of claim 12, wherein the connection statistics are associated with a particular time period.

15. The system of claim 14, wherein the particular time period is one of the set comprising: a preceding second, a preceding minute, a preceding hour, a preceding day, and a preceding week.

16. The system of claim 14, wherein the contact distribution server is further operable to:
assign weights to the connection statistics, whereby the connection statistics associated with more recent times in the particular time period have higher weights than the connection statistics associated with earlier times in the particular time period; and
determine at least one reliability score based on the assigned weights.

17. The system of claim 12, wherein the contact distribution server is further operable to:
predict a future connection reliability for at least one of the plurality of resources using past trends in the connection statistics; and
determine the reliability score for the at least one of the plurality of resources based on the predicted connection reliability for the at least one of the plurality of resources.

18. The system of claim 12, wherein the contact distribution server is further operable to track connection statistics for a plurality of resources.

19. The system of claim 18, wherein the contact distribution server is further operable to:
send periodically a request message to at least one of the plurality of resources;
wait a predetermined period of time for a response; and
record a result based on the response and whether the response is received within the predetermined period of time.

20. The system of claim 12, wherein the contact comprises at least one of the set comprising: a voice communication, a video communication, and a data communication.

21. The system of claim 12,
wherein the contact distribution server is a teleconference server;
wherein the plurality of resources is a plurality of teleconference devices; and
where the teleconference server is further operable to:
receive a conference call request for the plurality of teleconference devices to begin at a target time;
determine a first reliability score for a first of the plurality of teleconference devices based at least in part upon connection statistics for the first of the plurality of teleconference devices;
determine a second reliability score for a second of the plurality of teleconference devices based at least in part upon connection statistics for the second of the plurality of teleconference devices; and
initiate a conference call between the plurality of teleconference devices if the first and the second reliability scores exceed a minimum threshold.

22. The system of claim 21, wherein the teleconference server is further operable to track connection statistics for the first and second of the plurality of teleconference devices.

23. A contact distribution server, comprising:
a memory, operable to store connection statistics associated with a plurality of resources; and
a processor communicatively coupled to the memory, where the processor is operable to:
receive a contact;
determine a reliability score for each of the plurality of resources based at least in part upon connection statistics for the plurality of resources;
determine a particular resource of the plurality of resources to which to route the contact based at least in part upon the determined reliability scores; and
route the contact to the particular resource.

24. The server of claim 23, wherein the connection statistics are based on at least one of the set comprising: dropped connections, connection speed, number of dropped packets, signal strength, and failure to establish connections.

25. The server of claim 23, wherein the connection statistics used to determine at least one reliability score are associated with a particular time period.

26. The server of claim 25, wherein the particular time period is one of the set comprising: a preceding second, a preceding minute, a preceding hour, a preceding day, and a preceding week.

27. The server of claim 25, wherein the processor is further operable to:
assign weights to the connection statistics, whereby the connection statistics associated with more recent times in the particular time period have higher weights than the connection statistics associated with earlier times in the particular time period; and
determine at least one reliability score based on the assigned weights.

28. The server of claim 23, wherein the processor is further operable to:
predict a future connection reliability for at least one of the plurality of resources using past trends in the connection statistics; and
determine the reliability score for the at least one of the plurality of resources based on the predicted connection reliability for the at least one of the plurality of resources.

29. The server of claim 23, wherein the processor is further operable to track connection statistics for a plurality of resources.

30. The server of claim 29, wherein the processor is further operable to:
send periodically a request message to at least one of the plurality of resources;
wait a predetermined period of time for a response; and
record a result based on the response and whether the response is received within the predetermined period of time.

31. The server of claim 23, wherein the contact comprises at least one of the set comprising: a voice communication, a video communication, and a data communication.

32. The server of claim 23,
wherein the plurality of resources is a plurality of teleconference devices; and
wherein the processor is further operable to:
receive a conference call request for the plurality of teleconference devices to begin at a target time;
determine a first reliability score for a first of the plurality of teleconference devices based at least in part upon connection statistics for the first of the plurality of teleconference devices;
determine a second reliability score for a second of the plurality of teleconference devices based at least in part upon connection statistics for the second of the plurality of teleconference devices; and
initiate a conference call between the plurality of teleconference devices if the first and the second reliability scores exceed a minimum threshold.

33. The server of claim 32, wherein the processor is further operable to track connection statistics for the first and second of the plurality of teleconference devices.

34. A contact routing system, comprising:
means for receiving a contact to be routed to one of a plurality of resources;
means for determining a reliability score for at least one of the plurality of resources based at least in part upon connection statistics for at least one of the plurality of resources;
means for determining a particular resource of the plurality of resources to which to route the contact based at least in part upon the determined reliability score; and
means for routing the contact to the particular resource.
